(19) United States
(12) Patent Application Publication
(10) Pub. No.: US 2026/0015162 A1
(43) Pub. Date: Jan. 15, 2026

(54) TRASH CAN WITH AUTOMATIC PACKAGING FUNCTION

(71) Applicant: EKO GROUP LTD, Jiangmen (CN)

(72) Inventor: Yizhi CHEN, Jiangmen (CN)

(21) Appl. No.: 19/336,399

(22) Filed: Sep. 22, 2025

(30) Foreign Application Priority Data
Oct. 30, 2024 (CN) 202411531743.1

(51) Int. Cl. B65F 1/06; B65F 1/16

(52) U.S. Cl. CPC B65F 1/06; B65F 1/16; B65F 2001/1653; B65F 2210/167

(57) ABSTRACT

A trash can with an automatic packaging function includes a trash can body and a lid. The trash can body is upwardly provided with an opening, and the lid is configured to cover the opening. The opening is provided with a closure mechanism. A middle of the closure mechanism is provided with a trash inlet. The middle of the closure mechanism is communicated with the trash inlet. An opening of the garbage bag is sleeved at the trash inlet, and a main body of the garbage bag is configured to pass through the middle of the closure mechanism. The closure mechanism is provided with a cavity around the trash inlet. The cavity is communicated with the trash inlet. The closure mechanism includes a heat-sealing unit, a limit block, a flexible belt and a drive wheel provided in the cavity.

### CROSS-REFERENCE TO RELATED APPLICATIONS

This application claims the benefit of priority from Chinese Patent Application No. 202411531743.1, filed on Oct. 30, 2024. The content of the aforementioned application, including any intervening amendments thereto, is incorporated herein by reference in its entirety.

### TECHNICAL FIELD

This application relates to trash cans, and more particularly to a trash can with an automatic packaging function.

### BACKGROUND

Higher and higher requirements have been raised for garbage collection and disposal with the development of society and the improvement of living standards. Tradition trash cans have many drawbacks during the practical application, such as diffusion of unpleasant odors caused by poor sealing effect, manual tying, and cumbersome closure operation. In addition, some private items such as diapers and sanitary pads inside the trash can may discomfort the users when a lid of the trash can is opened. Therefore, with the development of social science and technology, higher requirements have been put forward for trash cans in terms of functions, such as preventing spread of unpleasant odors, infections and privacy exposure, and automatic sealing.

In order to solve these problems, trash cans that can automatically package garbage bags have gradually emerged in the market, which significantly enhances the automation degree in the garbage disposal. These trash cans usually adopt one or two pressure rods/plates to press an opening of the garbage bag towards an edge of the opening of the trash can, and then a sealing device cooperates with the pressure rods/plates to complete sealing and packaging. In the prior art, Chinese Patent No. 106564717B developed an automatic heat-sealing device for garbage bag for trash cans and method thereof, where a clamping plate is configured to be pushed by a driving mechanism to move towards a heating module, and when the clamping plate is contact with the heating mechanism, the opening of the garbage bag is closed, at this time, the heating module is started to melt the opening of the garbage bag.

However, the prior art still has the following disadvantages in practical application.
(1) The structure of the device in the prior art are complex. The required additional components, such as sliding blocks, guide rails, clamping plates, and synchronous wheel assemblies, are cumbersomely controlled and have high manufacturing cost.
(2) The clamping plate and the heating module are made of rigid materials, and have relatively large contact area, which helps improve sealing efficiency, while easily causes damage to the garbage bag caused by excessive heating, affecting packaging effect and subsequent processing.
(3) Due to light and thin material of the garbage bag, it is prone to be stuck at corners of the pressure plates or pressure rods, which makes it impossible to close the garbage bag or even directly damages the garbage bag, reducing the user experience.
(4) Most of the pressure plate/pressure rod have a strip structure, and a side of the pressure plate/pressure rod that is contact with the heating module has a flat structure. Once the pressure plate/pressure rod bends, deformation will occur on the flat structure. Such deformation will cause that the garbage bag after being pressed cannot be fully contact with the heating module, it is easy to causes poor sealing of the garbage bag, which affects packing effects and will also reduce the reliability and practicality of packaging.

Therefore, it is an urgent need for an automatic packaging trash can to solve the above problems.

### SUMMARY

In view of the above problems, this application provides an automatic packaging trash can to solve relevant technical problems in the prior art. In this application, a drive wheel is configured to drive a flexible belt to automatically wind from an inner side of a rail to a heat-sealing unit, and then the heat-sealing unit is configured to press, fuse and seal an opening of a garbage bag, which greatly simplifies the process of sealing the garbage bag. In such way, the user doesn't need to gather and bind an opening of the garbage bag, which reduces direct contact between the user and garbage and risks of pathogen transmission, and is conducive to preventing the spread of the unpleasant smell from garbage.

Technical solutions of this application are described as follows.

This application provides a trash can with an automatic packaging function, comprising:
a lid;
wherein a bottom of the lid is provided with a closure mechanism; a middle of the closure mechanism is provided with a trash inlet; and an opening of a garbage bag is arranged within the trash inlet;
the opening of the garbage bag is sleeved at the trash inlet, and a main body of the garbage bag is configured to pass through the middle of the closure mechanism; the closure mechanism is provided with a cavity around the trash inlet, and the cavity is in an annular shape; an interior of the cavity is open, and is communicated with the trash inlet; a support part is provided in the cavity; and the support part is spirally provided with a first track extending from inside to outside;
the closure mechanism comprises a heat-sealing unit, a limit block, a flexible belt and a drive wheel; the heat-sealing unit, the limit block, the flexible belt and the drive wheel are provided in the cavity; a first end of the heat-sealing unit is connected with a first end of the flexible belt, and a second end of the heat-sealing unit is provided with the drive wheel; a second end of the flexible belt is configured to extend along the first track and pass through the limit block to be drivably connected with the drive wheel; and the drive wheel is configured to rotate to drive the flexible belt to be elastically gathered or stretched;
in response to a case that the flexible belt is gathered from an inner side of the first track to the heat-sealing unit, the heat-sealing unit, the limit block and the flexible belt are configured to enclose to form a close state, the flexible belt is configured to close the opening of the garbage bag to the heat-sealing unit, and the heat-sealing unit is configured to press and thermally seal the opening of the garbage bag; and
the drive wheel is configured to reversely rotate to allow the heat-sealing unit to be separated from the limit block and the flexible belt to be stretched along the first track, so as to release the garbage bag.

In an embodiment, the heat-sealing unit comprises a first clamping arm and a second clamping arm; the first clamping arm comprises a connecting end and an articulated end; the connecting end of the first clamping arm is connected with the flexible belt; the articulated end of the first clamping arm is rotatably provided in the cavity; the second clamping arm is fixedly provided in the cavity, and is located at a side of the articulated end of the first clamping arm; the flexible belt is configured to drive the first clamping arm to rotate around the articulated end, so as to drive the first clamping arm to be close to or away from the second clamping arm; and
the second clamping arm comprises a heat insulating base and a heating element; the heat insulating base is located at the side of the articulated end, and the heating element is configured to thermally seal the opening of the garbage bag; a side of the heat insulating base facing towards the opening of the garbage bag is provided with a heat-pressing surface; the heat-pressing surface is arranged along a length direction of the second clamping arm, and the heating element is arranged on the heat-pressing surface; and a side of the first clamping arm facing towards the garbage bag is provided with a pressing surface, and the pressing surface is configured to clamp the garbage bag with the heat-pressing surface.

In an embodiment, the cavity comprises a top plate and a bottom plate; the top plate is located at an upper side of the cavity, and the bottom plate is located at a lower side of the cavity; the top plate and the bottom plate are configured to enclose the cavity; the articulated end of the first clamping arm is rotatably connected with the top plate; the bottom plate is configured as the support part; and the first clamping arm is provided with a pressing platform configured to extend from the articulated end to the connecting end, and the pressing surface is formed on a side of the pressing platform;
the closure mechanism further comprises a rotating shaft and a rotating groove; the rotation shaft is provided on the top plate; the rotating groove is arranged on the first clamping arm, and is configured to rotate around the rotating shaft; and
the first clamping arm has a 7-shaped structure; and an axis of the rotating groove is configured to deviate from the pressing platform in a direction close to the second clamping arm, and an angle is formed between the pressing platform and a plane passing the axis of the rotating groove.

In an embodiment, an end of the heat insulating base away from the first clamping arm is provided with a flange; the flange is provided along the length direction of the second clamping arm, and a height of the flange is less than that of the heat insulating base; the limit block is provided with a clamping opening, and the clamping opening is configured to allow the flange to pass through; the height of the flange is less than that of the clamping opening; and in response to a case that the flange is engaged with the clamping opening, the flexible belt is configured to stop closing the garbage bag; and
the heating element is a strip-shaped heating wire.

In an embodiment, the limit block is provided with a sliding groove, and the sliding groove is configured to allow the flexible belt to pass through; the flexible belt is configured to pass through the sliding groove to be drivably connected with the limit block; the top plate is provided with a guide rail configured to allow the limit block to slide; a top of the limit block is provided with a protrusion, and the protrusion is slidably connected with the guide rail; and a width of the guide rail is larger than a diameter of the protrusion.

In an embodiment, the trash can further comprises an elastic element; a first end of the elastic element is fixedly connected with the top plate, and a second end of the elastic element is elastically connected with the protrusion; and an elastic extension direction of the elastic element is the same as an extension direction of the guide rail.

In an embodiment, the flexible belt is configured to be clamped into the sliding groove from top to bottom or bottom to top, and a width of the sliding groove is larger than a thickness of the flexible belt, so that the flexible belt is in a clearance fit with the sliding groove.

In an embodiment, the first track is composed of a plurality of linear segments, a plurality of arc segments or a combination thereof that are connected in sequence, and a connection between adjacent segments is configured to be arc transition.

In an embodiment, a first end and a second end of the first track are both configured to be inclined; the first end of the first track is configured to be close to the trash inlet along an extension direction of the first track; and the second end of the first track is configured to be away from the trash inlet along the extension direction of the first track, so that an area between a position near an intersection point of the first end of the first track and the second end of the first track and an inner boundary of the support part increases.

In an embodiment, the drive wheel is in transmission connection with a drive element; the drive wheel is a toothed winding reel; and the flexible belt is provided with an engagement section in transmission connection with the drive wheel.

In an embodiment, the drive element is a drive motor, and the drive motor is configured to directly or indirectly drive the drive wheel to rotate; and
the trash inlet is a cyclic structure, and the cyclic structure has a cross-section in circular-shaped, elliptical-shaped or polygonal-shaped.

In an embodiment, an upper end of the top plate is provided with a rim articulated with the lid.

The present disclosure has the following beneficial effects.
(1) In this application, the drive wheel is driven to rotate to drive the flexible belt to automatically wind and unwind. The opening of the garbage bag is gathered to the heat-sealing unit by the flexible belt. The heat-sealing unit is configured to press the opening of the garbage bag and heat to seal the opening. Such design greatly simplifies the process of sealing the opening, and the user doesn't need to gather and bind an opening of the garbage bag. Besides, the flexible belt gathers under the drive of the drive wheel, the gathering flexible belt gradually drives the garbage bag to a heating are of the heat-sealing unit, at the same time, the flexible belt is also a power source to drive the heat-sealing unit to clamping the garbage bag. Through one power source, that is, the flexible belt, the present disclosure can simultaneously realize multiple functions that driving the garbage bag, clamping the garbage bag and sealing the opening of the garbage bag, which greatly simplifies complexity of a whole structure and reduces production cost.
(2) Compared with a sealing structure of press rod/press plate in the prior art, the closure mechanism of the present disclosure is simpler, and has simple process of winding or unwinding the flexible belt. The present disclosure, through utilizing a layout of the cavity, the limit block and the track, not only makes the process of winding or unwinding the flexible belt smoother, but also makes a structure of the closure mechanism more compact.
(3) In the present disclosure, the process of automatically gathering the garbage bag reduces direct contact between the user and garbage, and reduces risks of pathogen transmission. Besides, the closed garbage bag prevents garbage leakage and breeding of mosquitoes, which improves public health level and makes it safer. The present disclosure is also conducive to preventing the spread of the unpleasant smell from garbage and keeps freshness of a surrounding environment.

### BRIEF DESCRIPTION OF THE DRAWINGS

FIG. 1 is a structural diagram of an automatic packaging trash can according to an embodiment of the present disclosure.

FIG. 2 is a sectional view of the automatic packaging trash can according to an embodiment of the present disclosure.

FIG. 3 is a structural diagram of a closure mechanism according to an embodiment of the present disclosure.

FIG. 4 is a structural diagram of the closure mechanism without some components according to an embodiment of the present disclosure.

FIG. 5 is an explosive diagram of the closure mechanism according to an embodiment of the present disclosure.

FIG. 6 is a sectional view of the closure mechanism according to an embodiment of the present disclosure.

FIG. 7 is an enlarged view of portion “A” in FIG. 6.

FIG. 8 is a structural diagram of a heat-sealing unit in an open state according to an embodiment of the present disclosure.

FIG. 9 is a structural diagram of a first clamping arm according to an embodiment of the present disclosure.

FIG. 10 is structural diagram of a second clamping arm according to an embodiment of the present disclosure.

FIG. 11 is a structural diagram of the heat-sealing unit in a clamping state according to an embodiment of the present disclosure.

FIG. 12 is a top view of the heat-sealing unit according to an embodiment of the present disclosure.

FIG. 13 is a structural diagram of a limit block according to an embodiment of the present disclosure.

FIG. 14 is a structural diagram of the limit block at another angle according to an embodiment of the present disclosure.

FIG. 15 is a working diagram of the flexible belt gradually winding from an inner side of a first track according to an embodiment of the present disclosure.

FIG. 16 is a structural diagram of a heating element according to an embodiment of the present disclosure.

In Figures: 1, first clamping arm; 11, pressing platform; 111, pressing surface; 12, rotating groove; 13, angle; 14, avoidance groove; 15, connecting groove; 151, connecting hole; 16, connecting end; 17, articulated end; 2, second clamping arm; 21, heat insulating base; 211, heat-pressing surface; 212, protruding block; 2131, first limit groove; 2132, second limit groove; 214, third limit groove; 215, mounting groove; 2151, mounting hole; 22, flange; 23, heating element; 24, first end portion; 25, extension portion; 26, second end portion;

3, lid; 4, closure mechanism; 41, trash inlet; 42, top plate; 421, rotating shaft; 422, guide rail; 423, first limit portion; 424; first guide portion; 43, bottom plate; 431, second limit portion; 432, second guide portion; 44, cavity; 45, first track; 451, first end of first track; 452, second end of first track; 46, guide port; 47, abutting part; and

5, limit block; 51, sliding groove; 52, protrusion; 53, clamping opening; 6, flexible belt; 7, drive wheel; 8, elastic element; 9, rim; and 10, heat-sealing unit.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

In the disclosure, it should be noted that the terms, such as “central”, “longitudinal”, “transverse”, “lengthwise”, “widthwise”, “thickness”, “up”, “down”, “front”, “rear”, “left”, “right”, “vertical”, “horizontal”, “top”, “bottom”, “inner”, “outer”, “clockwise”, “counter-clockwise” and other directional indications used herein, are only used for illustrating relative position relationship and motion between components in a specific state (as shown in the accompanying drawings), rather than limiting the disclosure.

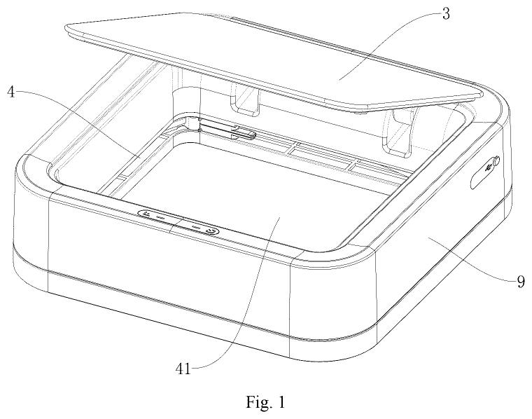

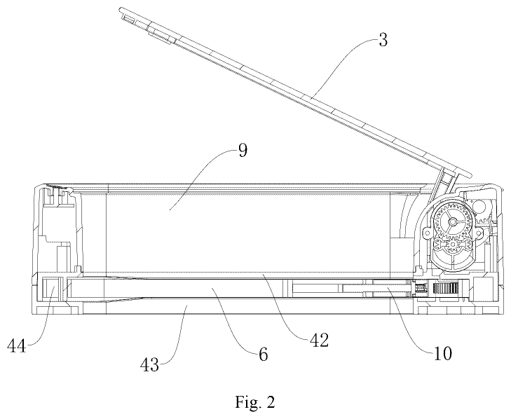

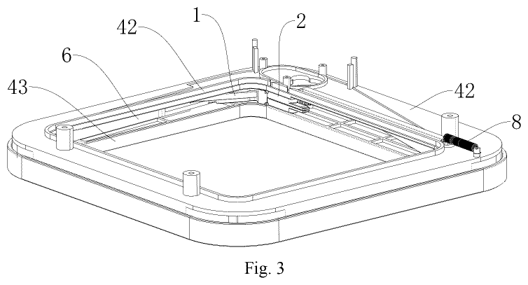

Referring to FIGS. 1-5, a trash can with an automatic packaging function includes a trash can body and a lid 3. The trash can body is upwardly provided with an opening of the trash can, and the lid 3 is configured to cover the opening of the trash can. The opening of the trash can is provided with a closure mechanism 4. A middle of the closure mechanism 4 is provided with a trash inlet 41. A chamber configured to be placed with the garbage bag is provided within the trash can body, and an opening of the garbage bag is arranged within the trash inlet 41.

The middle of the closure mechanism 4 is communicated with the trash inlet 41. The opening of the garbage bag is sleeved at the trash inlet 41, and a main body of the garbage bag is configured to pass through the middle of the closure mechanism 4. The closure mechanism 4 is provided with a cavity 44 around the trash inlet 41, and the cavity 44 is in an annular shape. An interior of the cavity 44 is open, and is communicated with the trash inlet 41 of the trash can. A support part is provided in the cavity 44. The support part is spirally provided with a first track 45 extending from inside to outside.

The closure mechanism 4 further includes a heat-sealing unit 10, a limit block 5, a flexible belt 6 and a drive wheel 7. The heat-sealing unit 10, the limit block 5, the flexible belt 6 and the drive wheel 7 are provided in the cavity. A first end of the heat-sealing unit 10 is connected with a first end of the flexible belt 6, and a second end of the heat-sealing unit 10 is provided with the drive wheel 7. a second end of the flexible belt 6 is configured to extend along the first track 45 and pass through the limit block 5 to be drivably connected with the drive wheel 7. the drive wheel 7 is configured to rotate to drive the flexible belt 6 to elastically be gathered or stretched.

In response to a case that the flexible belt 6 is wound from an inner side of the first track 45 to the heat-sealing unit 10, the heat-sealing unit 10, the limit block 5 and the flexible belt 6 are configured to enclose to form a close state, the flexible belt 6 is configured to close the opening of the garbage bag to the heat-sealing unit 10, and the heat-sealing unit 10 is configured to press and thermally seal the opening of the garbage bag. The drive wheel 7 is configured to reversely rotate to allow the heat-sealing unit 10 to be separated from the limit block 5 and the flexible belt 6 to be stretched along the first track 45, so as to release the garbage bag.

In this embodiment, the drive wheel 7 is configured to drive the flexible belt 6 to be gathered or stretched, which greatly simplifies the process of sealing the opening of the garbage bag, such that the user doesn't need to gather and bind an opening of the garbage bag, which improves convenience and efficiency of using the trash can, and is conducive to preventing the spread of the unpleasant smell from garbage.

Compared with a sealing structure of press rod/press plate in the prior art, the closure mechanism 4 of the present disclosure is simpler, and has simple process of winding or unwinding the flexible belt 6.

The heat-sealing unit 10 is utilized to heat and seal the opening of the garbage bag. Compared with the traditional manual binding or additional use of tape for sealing, it is more environmentally friendly and material-saving.

In addition, the closure mechanism 4 is provided on the opening of the trash can, so that the closure mechanism 4 can be applied to more trash cans. The limit block 5 is provided in the cavity 44, in response to a case that the flexible belt 6 is gathered to drive the limit block 5 to move along the cavity 44, the limit block 5 can prevent the flexible belt 6 from shifting, so that the flexible belt 6 can be gathered or stretched smoother, and a whole structure of the trash can is more compact, which doesn't occupy too much additional space, and is suitable for use in various environments, such as homes and offices.

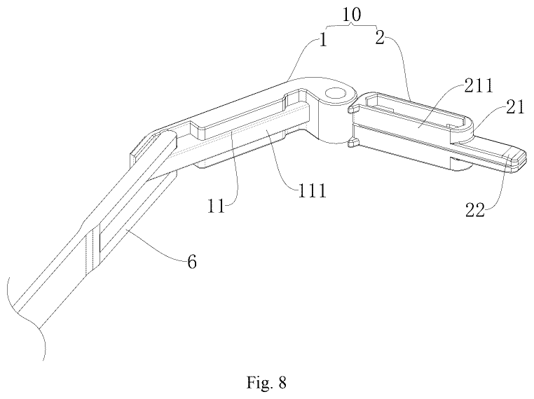

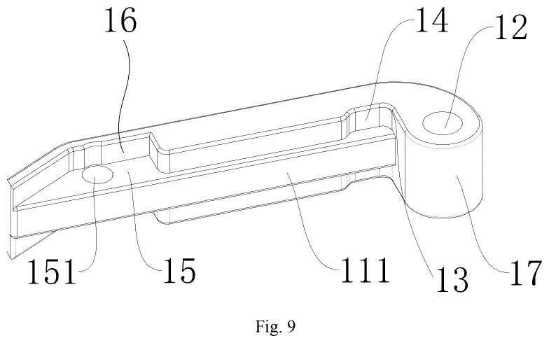

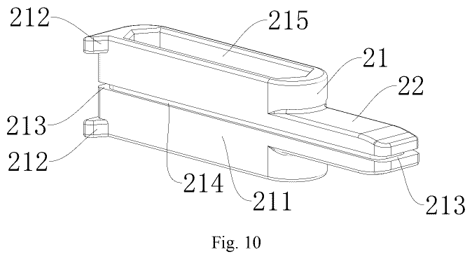

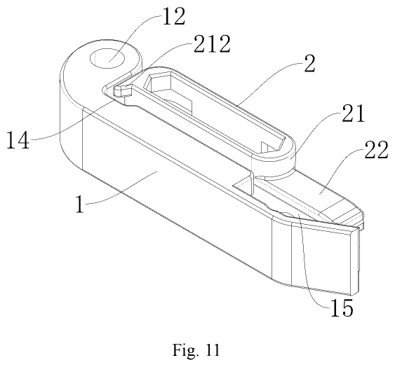

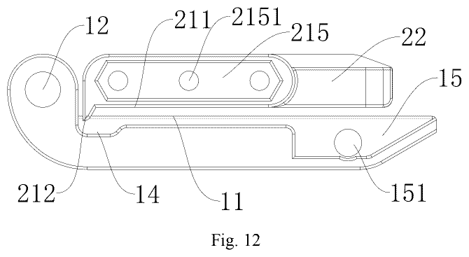

Referring to FIGS. 8-12, the heat-sealing unit 10 includes a first clamping arm 1 and a second clamping arm 2. The first clamping arm 1 includes a connecting end 16 and an articulated end 17. The connecting end 16 of the first clamping arm 1 is connected with the flexible belt 6. The articulated end 17 of the first clamping arm 1 is rotatably provided in the cavity 44. The second clamping arm 2 is fixedly provided in the cavity 44, and is located at a side of the articulated end 17 of the first clamping arm 1. The flexible belt 6 is configured to drive the first clamping arm 1 to rotate around the articulated end 17, so as to drive the first clamping arm 1 to be close to or away from the second clamping arm 2.

In this embodiment, the flexible belt 6 is continuously gathered under the drive of the drive wheel 7, and the gathering flexible belt 6 gradually drives the garbage bag to a heating are of the heat-sealing unit 10, at the same time, the flexible belt 6 is also a power source to drive the first clamping arm 1 and the second clamping arm 2 to clamp. Through one power source, that is, the flexible belt 6, the present disclosure can simultaneously realize multiple functions that driving the garbage bag, clamping the garbage bag and sealing the opening of the garbage bag, which greatly simplifies complexity of a whole structure and reduces production cost.

The second clamping arm 2 includes a heat insulating base 21 and a heating element 23. The heating element 23 is configured to thermally seal the opening of the garbage bag. A side of the heat insulating base 21 facing towards the opening of the garbage bag is provided with a heat-pressing surface 211. The heat-pressing surface 211 is arranged along a length direction of the second clamping arm 2, and the heating element 23 is arranged on the heat-pressing surface 211. A side of the first clamping arm 1 facing towards the garbage bag is provided with a pressing surface 111, and the pressing surface 111 is configured to clamp the garbage bag with the heat-pressing surface 211.

In this embodiment, the heat-sealing unit 10 with a clamp-type heat-sealing structure, through designing a clamping mechanism of the first clamping arm 1 and the second clamping arm 2, makes the heat-sealing unit 10 has a clamping function that similar to a clamp, which effectively realizes high efficiency heating and sealing of the closed garbage bag. Under the drive of the flexible belt 6, the first clamping arm 1 is configured to rotate around a rotating shaft of the articulated end 17, so as to drive the connecting end 6 to be close to the second clamping arm 2 and clamp with the second clamping arm 2. In this process, the heating element 23 on the second clamping arm 2 is configured to heat a plastic material of the garbage bag, which not only melts the garbage bag, but also causes materials on both sides of a cut to soften and partially fuse due to high temperature to form an initial sealing. At the same time, the pressing surface 111 of the first clamping arm 1 is tightly clamped with the heat-pressing surface 211 of the second clamping arm 2 during heating process, and applied pressure can enable the molten plastic material to fully contact and melt. Then, the plastic material solidifies to form a well-sealed sealing. A flat design of the pressing surface 111 and the heat-pressing surface 211 can ensure uniform pressure distribution, avoiding poor fusion caused by insufficient local pressure. Therefore, the clamp-type heat-sealing structure of the present disclosure can ensure the integrity and sealing of the molten sealing, such design greatly simplifies sealing mechanism of the garbage bag, improves the sealing efficiency, and is easy to operate.

At the same time, the clamping operation mode integrates the heating element 23 inside the second clamping arm 2. When the first clamping arm 1 and the second clamping arm 2 are closed, the heating element 23 is completely wrapped within the first clamping arm 1 and the second clamping arm 2, isolating direct contact between the operator and the heating element 23 and reducing possible accidental injury during the heating element 23 seals, which further enhances using safety of the product.

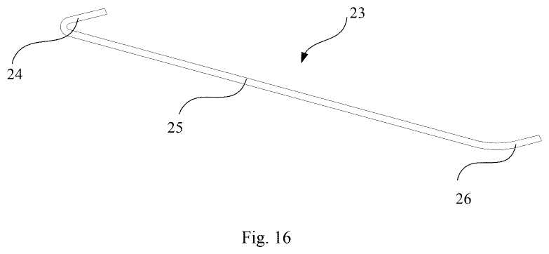

In an embodiment, referring to FIG. 16, the second clamping arm 2 further includes a first limit groove 2131, a second limit groove 2132 and a third limit groove 214. The first limit groove 2131 is provided on an end of the heat insulating base 21 away from the flange 22. The second limit groove 2132 is provided at an end of the flange 22 away from the first clamping arm. The third limit groove 214 is arranged at a middle of the heat-pressing surface 211. A first end of the third limit groove 214 is communicated with the first limit groove 2131, and a second end of the third limit groove 214 is communicated with the second limit groove 2132. The first limit groove 2131, the second limit groove 2132 and the third limit groove 214 are located on the same plane. The heating element 23 includes a first end portion 24, an extension portion 25 and a second end portion 26 connected in sequence. The first end portion 24 is arranged in the first limit groove 2131. The extension portion 25 is configured to extend from an end of the first limit groove 2131 along the third limit groove 214. The second end portion 26 is arranged in the second limit groove 2132.

In an embodiment, the heating element 23 has a U-shaped structure.

In an embodiment, the third limit groove 214 is arranged along the length direction of the second clamping arm 2. The extension portion 25 in the third limit groove 214 protrudes from the heat-pressing surface 211.

Through setting the first limit grove, the second limit groove 2132 and the third limit groove 214 connected in sequence, and setting the heating element 23 in the first limit grove, the second limit groove 2132 and the third limit groove 214, a position of the heating element 23 is limited to avoid insufficient sealing of the garbage bag caused by offset and bending of the heating element 23. In addition, through setting the heat insulating base 21, and setting the heating element 23 in the first limit grove 2131, the second limit groove 2132 and the third limit groove 214, heat of the heating element 4 is prevent from escaping from the heat insulating base 21, ensuring the heat can be concentrated and evenly applied to the garbage bag, and avoiding safety hazards caused by heat loss or local overheating.

In an embodiment, a top of the heat insulating base 21 is provided with a mounting groove, and a bottom of the heat insulating base 21 is provided with a mounting hole 2151. The mounting groove 215 is communicated with the mounting hole 2151. A top plate 42 is provided with a mounting part and a fastening component. The mounting part is configured to extend into the mounting groove 215. The fastening component is configured to sequentially pass through the mounting hole 2151 and the mounting part for fastening the heat insulating base 21 to the opening of the trash can.

The design of the mounting groove 215 and the mounting hole 2151 is conducive to fastening the second clamping arm 2 to avoid insufficient sealing of the garbage bag caused by loose of the second clamping arm 2.

In an embodiment, the cavity 44 includes the top plate 42 and a bottom plate 43. The top plate 42 is located at an upper side of the cavity 44, and the bottom plate 43 is located at a lower side of the cavity 44. The side of the top plate 42 away from the opening of the trash can is configured to extend to the bottom plate 43 to form a first side plate, or the side of the bottom plate 43 away from the opening of the trash can is configured to extend to the top plate 42 to form a second side plate. The top plate 42, the bottom plate 43 and the first side plate, or the top plate 42, the bottom plate 43 and the second side plate are configured to enclose the cavity 44. The bottom plate 43 is configured as the support part. The articulated end 17 of the first clamping arm 1 is rotatably connected with the top plate 42 in the cavity 44. The connecting end 16 of the first clamping arm 1 is connected with the flexible belt 6. The first clamping arm 1 is provided with a pressing platform 11 configured to extend from the articulated end 17 to the connecting end 16, and the pressing surface 111 is formed on a side of the pressing platform 11.

The closure mechanism 4 includes the rotating shaft 421 and a rotating groove 12. The rotating shaft 421 is provided on the top plate 42. The articulated end 17 of the first clamping arm 1 is provided with the rotating groove 12. The mounting groove 12 is arranged along the articulated end 17. The rotating shaft 421 is pivotally connected to the rotating groove 12. The rotating groove 12 is configured to rotate around the rotating shaft 421. The first clamping arm 1 is configured to rotate around an axis of the mounting groove 12 under the drive of the flexible belt 6.

The first clamping arm 1 has a 7-shaped cross section. The axis of the rotating groove 12 is configured to deviate from the pressing platform 11 in a direction close to the second clamping arm 2. An angle 13 is formed between the pressing surface 111 and a plane passing through the axis of the rotating groove 12, and the angle 13 is 90°.

In an embodiment, the first clamping arm further includes two protruding blocks 212. The two protruding blocks 212 are provided on an end of the heat insulating base 21 close to the articulated end. Each of the two protruding blocks 212 is configured to protrude from the heat-pressing surface 211, and the two protruding blocks 212 are symmetrically arranged along a vertical direction. The first clamping arm 1 is provided with two avoidance grooves 14 at the angle, and the two avoidance grooves 14 are configured to fit the two protruding blocks 212, respectively. The two avoidance grooves 14 are symmetrically arranged on two sides of the pressing platform 11 along the vertical direction.

In this embodiment, the design of the two protruding blocks 212 and the two avoidance grooves 14 is conducive to preventing the garbage bag from getting stuck in a gap between the first clamping arm 1 and the second clamping arm 2, so as to ensure the garbage bag can be completely melted and sealed.

In an embodiment, in the process of gathering, the garbage bag enters the pressing platform 11, the two protruding blocks 212 symmetrically arranged along a vertical direction of the heat insulating base 21 and the two avoidance grooves 14 symmetrically arranged on two sides of the pressing platform 11 along the vertical direction can play a limiting role, which prevents the garbage bag from overflowing at the area of the pressing platform 11, ensures a heating area covers the entire range and prevents the garbage bag from leaking and melting at the edge.

In an embodiment, the connecting end 16 of the first clamping arm 1 is provided with two connecting grooves 15, and the two connecting grooves 15 are symmetrically arranged on two sides of the pressing platform 11 along a vertical direction. The pressing platform 11 is provided with a connecting hole 151, and the connecting hole 151 is configured to pass through the two sides of the pressing platform 11 along the vertical direction. The two connecting grooves 15 are communicated with each other through the connecting hole 151. The flexible belt 6 is connected with the first clamping arm 1 through the connecting hole 151, so as to drive the first clamping arm 1 to rotate.

In an embodiment, the design of the connecting groove 15 and the connecting hole 151 makes a connection between the flexible belt 6 and the first clamping arm 1 more secure, so as to ensure the flexible belt 6 can drive the first clamping arm 1 to completely gather the garbage bag to the heating area of the heat-sealing unit 10.

In an embodiment, an end of the second clamping arm 2 away from the heat insulating base 21 is provided with a flange 22. The flange 22 is configured to protrude along the length direction of the second clamping arm 2. A thickness of the flange 22 is less than that of the heat insulating base 21. The limit block 5 is provided with a clamping opening 53 configured to allow the flange 22 to pass through. A height of the flange 22 is less than that of the clamping opening 53. When the flange 22 is completely clamped with the clamping opening 53, the flexible belt 6 stops gathering.

In an embodiment, the flange 22 is provided with a tip configured to be inserted into the clamping opening 53.

The design of the flange 22 and the clamping opening 53 ensures that in response to a case that the limit block 5 is connected with the heat-sealing unit 10, the flexible belt 6 is tightened and is completely placed within the heating area of the heat-sealing unit 10, which further improve the effect of sealing the garbage bag, reduces risks of leakage during sealing.

In an embodiment, the heating element 23 is a strip-shaped heating wire.

In an embodiment, the e third limit groove 214 is arranged along the length direction of the second clamping arm 2. In response to a case that the heating element 23 is located in the third limit groove 214, the extension portion 25 of the heating element 23 protrudes from the heat-pressing surface 211.

In this embodiment, the heating element 23 is the strip-shaped heating wire, such design is conducive to linear melting of the garbage bag, so that the garbage bag can be split in two at the melting position. At the same time, such design is also conducive to reducing the contact area between the garbage bag and the heating element 23, which avoids damage to the garbage bag due to excessive heating.

In an embodiment, the heat-sealing unit 10, except for the heating element 23, is made of a heat-insulating material, in this way, heat generated by the heat-sealing unit 10 in the working process can be effectively prevented from transferring to an external environment, and damage on the garbage bag and the trash can caused by overheating can be reduced. The heating element 23 is electrically connected with a heating circuit.

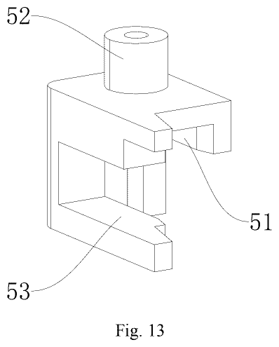

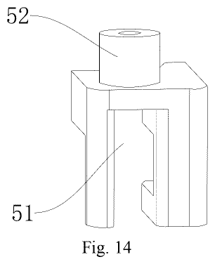

Referring to FIGS. 13-14, the limit block 5 is provided with a sliding groove 51, and the sliding groove 51 is configured to allow the flexible belt 6 to pass through. The flexible belt 6 is configured to pass through the sliding groove 51 to be drivably connected with the limit block 5. The top plate 42 in the cavity 44 is provided with a guide rail 422 configured to allow the limit block 5 to slide. A top of the limit block 5 is provided with a protrusion 52, and the protrusion 52 is slidably connected with the guide rail 422. A width of the guide rail 422 is larger than a diameter of the protrusion 52.

The design of the sliding groove 51, not only enables the flexible belt 6 to smoothly pass through, but also prevents the flexible belt 6 from deviating from the first track 45, so that the process of winding or unwinding the flexible belt 6 more fluent. At the same time, the design of the limit block 5 is conducive to guiding the flexible belt 6 to be gathered within the heating area of the heat-sealing unit 10, which avoids leakage problem caused by insufficient sealing of the garbage bag.

In an embodiment, the trash can further includes an elastic element 8. A first end of the elastic element 8 is fixedly connected with the top plate 42, and a second end of the elastic element 8 is elastically connected with the protrusion 52. An elastic extension direction of the elastic element 8 is the same as an extension direction of the guide rail 422. The elastic element 8 is a spring.

The elastic element 8 being stretched produces a counter-acting force, so as to drive the limit block 5 to return along the guide rail 422.

In an embodiment, the flexible belt 6 is configured to be clamped into the sliding groove 51 from top to bottom or bottom to top, and a width of the sliding groove 51 is larger than a thickness of the flexible belt 6, so that the flexible belt 6 is in a clearance fit with the sliding groove 51.

In response to a case that the flexible belt 6 is in the clearance fit with the sliding groove 51, a movement speed of the flexible belt 6 during being tightened is greater than that of the limit block 5. Due to the flexible belt 6 and the limit block 5 move synchronously, a movement stroke of the limit block 5 is shortened while ensuring its function, a volume of the limit block 5 is reduced, and a mounting space of the limit block 5 is saved.

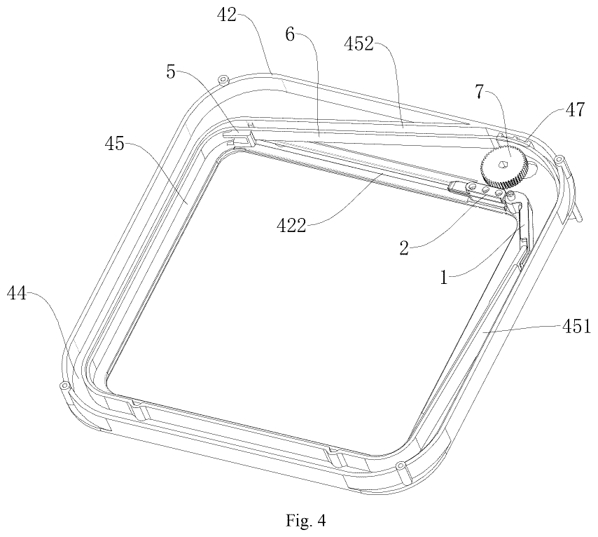

Referring to FIG. 4, the first track 45 is composed of a plurality of linear segments, a plurality of arc segments or a combination thereof that are connected in sequence, and a connection between adjacent segments is configured to be arc transition.

In an embodiment, a first end of the first track 451 and a second end of the first track 452 are both configured to be inclined. The first end of the first track 451 is configured to be close to the trash inlet 41 along an extension direction of the first track 45. The second end of the first track 452 is configured to be away from the trash inlet 41 along the extension direction of the first track 45, so that an area between a position near an intersection point of the first end of the track and the second end of the track and an inner boundary of the support part increases.

The second end of the first track 452 is connected with an inner wall of the first side plate or the second side plate, so that the inner wall of the first side plate or the second side plate is configured to form an extension part of the first track 45.

In an embodiment, an abutting part 47 is provided on the second end of the first track 452 or the extension part of the first track 45. The drive wheel 7 is drive the flexible belt 6 to perform a reciprocating motion, so as to abut the flexible belt 6 on the abutting part 47.

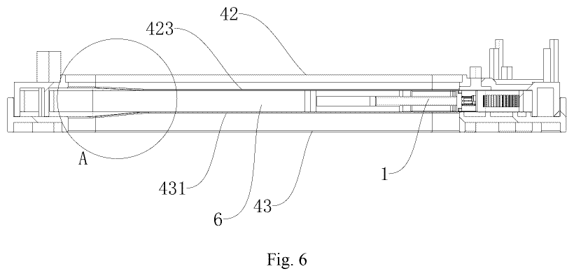

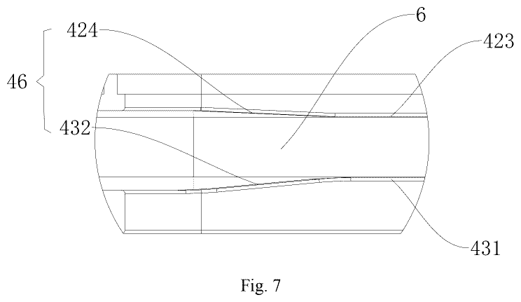

Referring to FIGS. 6-7, a side of the top plate 42 facing towards the first track 45 is provided with a first limit portion 423 corresponding to the first end of the first track 451 and the second end of the first track 452. A side of the bottom plate 43 facing towards the first track 45 is provided with a second limit portion 431 corresponding to the first end of the first track 451 and the second end of the first track 452. A corresponding part between the flexible belt 6 and the first end of the first track 451 and a corresponding part between the flexible belt 6 and the second end of the first track 452 are clamped between the first limit portion 423 and the second limit portion 431, respectively.

In an embodiment, a connection portion of the first limit portion 423 and the top plate 42 is inclined to form a first guide portion 424, and a connection portion of the second limit portion 431 and the bottom plate 43 is inclined to form a second guide portion 432. The first guide portion 424 and the second guide portion 432 are arranged relative to each other to form a guide port 46 in trumpet-shaped.

The guide port 46 is configured to guide the gathering flexible belt 6, so that the flexible belt 6 can be fluently clamped between the first limit portion 423 and the second limit portion 431, which improves fluency of the flexible belt 6 during gathering the flexible belt 6.

In an embodiment, for the first track 45, the number of spiral turns is one, less than one or larger than one.

In an embodiment, the drive wheel 7 is in transmission connection with a drive element. The drive wheel 7 is a toothed winding reel. The flexible belt 6 is provided with an engagement section in transmission connection with the drive wheel 7 to ensure a tooth on the toothed winding reel can fit with the engagement section, so that the toothed winding reel can drive the flexible belt 6 to perform the reciprocating motion better and more fluent, avoiding the flexible belt 6 to be out of control.

In an embodiment, the drive element is a drive motor, and the drive motor is configured to directly or indirectly drive the drive wheel 7 to rotate.

The trash inlet 41 is a cyclic structure, and the cyclic structure has a cross-section in circular-shaped, elliptical-shaped or polygonal-shaped.

In this embodiment, the opening of the trash can and the trash inlet 41 are not limited in common shapes, such as round, oval or square. The opening of the trash can and the trash inlet 41 can be designed into any shape according to actual use and aesthetic requirements.

In an embodiment, an upper end of the top plate 42 in the cavity 44 is provided with a rim 9 articulated with the lid 3. The main body of the trash can is connected with the lower end of the bottom plate 43 in the cavity 44. In this embodiment, the lid 3 and the rim 9 have sizes that thinner and lighter than those of similar products in same the same specification on the market, thereby increasing design space for shapes of the product.

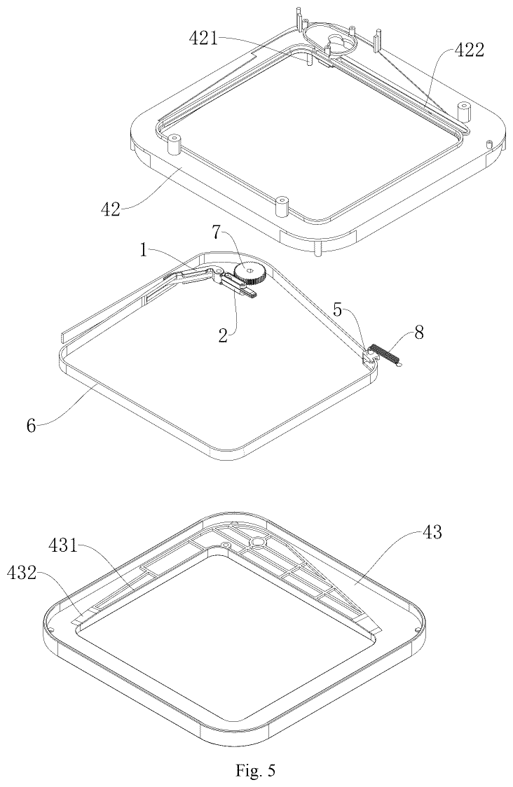

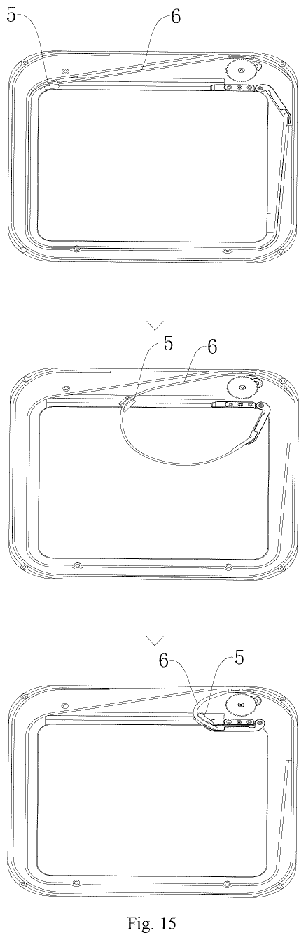

Referring to FIGS. 5, 8, 11 and 15, the trash can with the automatic packaging function is used as follows.

The drive element drives the drive wheel 7 to rotate, and the drive wheel 7 drives the flexible belt 6 to be gathered from the inner side of the first track 45 to the heat-sealing unit 10. The opening of the garbage bag is gathered by the flexible belt 6 to the heat-sealing unit 10. Under the drive of the flexible belt, the first clamping arm 1 rotates around the rotating shaft 421 to drive the connecting end 16 to close to the second clamping arm 2 and clamp with the second clamping arm 2. The pressing surface 111 clamps the garbage bag towards the heat-pressing surface 211. The garbage bag filled with garbage is melted by the heating wire and is separated from remaining garbage bags, at this time, the garbage bag filled with garbage is melted and connected at its opening, and the remaining garbage bags are melted at their bottom.

The drive element drives the drive wheel 7 to reversely rotate, and the drive wheel 7 drives the flexible belt 6 to be stretched. The flexible belt 6 drives the first clamping arm 1 to rotate around the rotating shaft 421 to reset along an original path. The flange is separated from the clamping opening. The second clamping arm 2 is separated from the limit block 5. At the same time, the flexible belt 6 is gradually stretched along the first track 45, and the opening of the garbage bag is out of pressing and is loosened.

According to disclosure and teaching of this specification, replacements and modifications can be made by those skilled in the art. Therefore, the present disclosure is not limited by disclosure above and specific embodiments. Any replacements and modifications made by those skilled in the art, shall fall within the scope of this application defined by the appended claims. In addition, some specific terms used in the specification are only illustrative, and are not intended to limit this application.

What is claimed is:

1. A trash can with an automatic packaging function, comprising a lid;
wherein a bottom of the lid is provided with a closure mechanism; a middle of the closure mechanism is provided with a trash inlet; and an opening of a garbage bag is arranged within the trash inlet;
the opening of the garbage bag is sleeved at the trash inlet, and a main body of the garbage bag is configured to pass through the middle of the closure mechanism; the closure mechanism is provided with a cavity around the trash inlet, and the cavity is in an annular shape; an interior of the cavity is open, and is communicated with the trash inlet; a support part is provided in the cavity; and the support part is spirally provided with a track extending from inside to outside;
the closure mechanism comprises a heat-sealing unit, a limit block, a flexible belt and a drive wheel; the heat-sealing unit, the limit block, the flexible belt and the drive wheel are provided in the cavity; a first end of the heat-sealing unit is connected with a first end of the flexible belt, and a second end of the heat-sealing unit is provided with the drive wheel; a second end of the flexible belt is configured to extend along the track and pass through the limit block to be drivably connected with the drive wheel; and the drive wheel is configured to rotate to drive the flexible belt to be elastically gathered or stretched;
in response to a case that the flexible belt is gathered from an inner side of the track to the heat-sealing unit, the heat-sealing unit, the limit block and the flexible belt are configured to enclose to form a close state, the flexible belt is configured to close the opening of the garbage bag to the heat-sealing unit, and the heat-sealing unit is configured to press and thermally seal the opening of the garbage bag; and
the drive wheel is configured to reversely rotate to allow the heat-sealing unit to be separated from the limit block and the flexible belt to stretch along the track, so as to release the garbage bag.

2. The trash can of claim 1, wherein the heat-sealing unit comprises a first clamping arm and a second clamping arm; the first clamping arm comprises a connecting end and an articulated end; the connecting end of the first clamping arm is connected with the flexible belt; the articulated end of the first clamping arm is rotatably provided in the cavity; the second clamping arm is fixedly provided in the cavity, and is located at a side of the articulated end of the first clamping arm; the flexible belt is configured to drive the first clamping arm to rotate around the articulated end, so as to drive the first clamping arm to be close to or away from the second clamping arm; and
the second clamping arm comprises a heat insulating base and a heating element; the heat insulating base is located at the side of the articulated end, and the heating element is configured to thermally seal the opening of the garbage bag; a side of the heat insulating base facing towards the opening of the garbage bag is provided with a heat-pressing surface; the heat-pressing surface is arranged along a length direction of the second clamping arm, and the heating element is arranged on the heat-pressing surface; and a side of the first clamping arm facing towards the garbage bag is provided with a pressing surface, and the pressing surface is configured to clamp the garbage bag with the heat-pressing surface.

3. The trash can of claim 2, wherein the cavity comprises a top plate and a bottom plate; the top plate is located at an upper side of the cavity, and the bottom plate is located at a lower side of the cavity; the top plate and the bottom plate are configured to enclose the cavity; the articulated end of the first clamping arm is rotatably connected with the top plate; the bottom plate is configured as the support part; and the first clamping arm is provided with a pressing platform configured to extend from the articulated end to the connecting end, and the pressing surface is formed on a side of the pressing platform;
the closure mechanism further comprises a rotating shaft and a rotating groove; the rotation shaft is provided on the top plate; the rotating groove is arranged on the first clamping arm, and is configured to rotate around the rotating shaft; and
the first clamping arm has a 7-shaped structure; and an axis of the rotating groove is configured to deviate from the pressing platform in a direction close to the second clamping arm, and an angle is formed between the pressing platform and a plane passing the axis of the rotating groove.

4. The trash can of claim 2, wherein an end of the heat insulating base away from the first clamping arm is provided with a flange; the flange is provided along the length direction of the second clamping arm, and a height of the flange is less than that of the heat insulating base; the limit block is provided with a clamping opening, and the clamping opening is configured to allow the flange to pass through; the height of the flange is less than that of the clamping opening; and in response to a case that the flange is engaged with the clamping opening, the flexible belt is configured to stop closing the garbage bag; and
the heating element is a strip-shaped heating wire.

5. The trash can of claim 3, wherein the limit block is provided with a sliding groove, and the sliding groove is configured to allow the flexible belt to pass through;
the flexible belt is configured to pass through the sliding groove to be drivably connected with the limit block; the top plate is provided with a guide rail configured to allow the limit block to slide; a top of the limit block is provided with a protrusion, and the protrusion is slidably connected with the guide rail; and a width of the guide rail is larger than a diameter of the protrusion.

6. The trash can of claim 5, further comprising:
an elastic element;
wherein a first end of the elastic element is fixedly connected with the top plate, and a second end of the elastic element is elastically connected with the protrusion; and
an elastic extension direction of the elastic element is the same as an extension direction of the guide rail.

7. The trash can of claim 5, wherein the flexible belt is configured to be clamped into the sliding groove from top to bottom or bottom to top, and a width of the sliding groove is larger than a thickness of the flexible belt, so that the flexible belt is in a clearance fit with the sliding groove.

8. The trash can of claim 1, wherein the track is composed of a plurality of linear segments, a plurality of arc segments or a combination thereof that are connected in sequence, and a connection between adjacent segments is configured to be arc transition.

9. The trash can of claim 1, wherein a first end and a second end of the track are both configured to be inclined; the first end of the track is configured to be close to the trash inlet along an extension direction of the track; and the second end of the track is configured to be away from the trash inlet along the extension direction of the track.

10. The trash can of claim 1, wherein the drive wheel is in transmission connection with a drive element; the drive wheel is a toothed winding reel; and the flexible belt is provided with an engagement section in transmission connection with the drive wheel; and
an upper end of the top plate is provided with a rim articulated with the lid.
